(19) United States
(12) Patent Application Publication
(10) Pub. No.: US 2015/0081690 A1
(43) Pub. Date: Mar. 19, 2015

(54) NETWORK SOURCED ENRICHMENT AND CATEGORIZATION OF MEDIA CONTENT

(71) Applicant: RUMBLEFISH, INC., PORTLAND, OR (US)

(72) Inventors: GIDEON AROM, LOS ANGELES, CA (US); ALEX T. STONE, LOS ANGELES, CA (US); FELLIPE EDUARDO BRITO, CURITIBA (BR); PEDRO MARTOS, CURITIBA (BR)

(73) Assignee: RUMBLEFISH, INC., PORTLAND, OR (US)

(21) Appl. No.: 14/481,061

(22) Filed: Sep. 9, 2014

Related U.S. Application Data
(60) Provisional application No. 61/875,250, filed on Sep. 9, 2013.

(51) Int. Cl. G06F 17/30

(52) U.S. Cl. CPC G06F 17/30696; G06F 17/30643
USPC 707/728

(57) ABSTRACT

Media content is enhanced and/or categorized through association with descriptive terms of a nomenclature that are obtained from network sources of information. In one example, a search query identifying a target media content item is received, and a search is performed based on the search query to obtain search result information for the target media content item. A schema defining a set of descriptive fields and an associated nomenclature of terms for each of the descriptive fields is referenced with regards to the search result information. The search result information is processed to identify a sampling metric for instances of the nomenclature of terms that are contained within text information of the search result for the descriptive fields. One or more suggested terms that have been selected from the nomenclature of terms for the descriptive fields are output for the target media content item based on the sampling metric.

### CROSS-REFERENCE TO RELATED APPLICATIONS

The present application claims priority to and is a non-provisional of U.S. provisional application Ser. No. 61/875,250, titled NETWORK SOURCED ENRICHMENT AND CATEGORIZATION OF MEDIA CONTENT, filed Sep. 9, 2013, the entire contents of which are incorporated herein by reference in their entirety for all purposes.

### BACKGROUND

Electronic information networks such as the Internet offer a vast array of information concerning virtually any topic of interest. Human generated content in the form of reviews, critiques, discussions, and editorials are published online via websites, weblogs, electronic publications, multi-party discussion forums, and social networks.

The Internet also enables its users to locate, purchase, and access a broad range of electronic media content in the form of musical works, television programs, movies, games, and electronic books or journals via the user's personal electronic devices. Consumers, content providers, and media professionals rely on search engines to locate, categorize, or filter large amounts of media content. Descriptive tags are commonly applied to individual media content items within the field of information retrieval and search engine optimization to enable or enhance search engine functionality.

### SUMMARY

In one aspect of the present disclosure, media content is enhanced and/or categorized through association with descriptive terms of a nomenclature that are obtained from third-party network sources of information. In one example, a search query identifying a target media content item is received, and a search is performed based on the search query to obtain search result information for the target media content item. The search result information includes text information captured from one or more third-party network resources.

A schema defining a set of descriptive fields and an associated nomenclature of terms for each of the descriptive fields is referenced with regards to the search result information. The search result information is processed to identify a sampling metric (e.g., a quantity or frequency) for instances of the nomenclature of terms that are contained within the text information for one or more of the descriptive fields. Natural language processing, including stemming and/or conflation, may be performed with respect to the search result information to facilitate the matching or mapping of terms contained within the search result information to terms contained within the nomenclature.

One or more suggested terms that have been selected from the nomenclature of terms for the one or more descriptive fields are output for the target media content item based, at least in part, on the sampling metric. The one or more suggested terms may be associated with the target media content item programmatically and/or through human intervention to enrich and/or categorize the target media content item, particularly within the context of a broader domain of media content items contained within a database system.

This Summary includes a selection of the various concepts described in greater detail by following the Detailed Description and associated drawings, and is not intended as limiting the scope of claimed subject matter.

### BRIEF DESCRIPTION OF DRAWINGS

FIG. 1 is a flow diagram depicting an example process by which a media content item in the form of a musical work is enriched and/or categorized.

FIG. 2 is a flow diagram depicting an example method of enriching and/or categorizing a media content item.

FIG. 3 is a schematic depiction of an example graphical user interface of a search tool.

FIG. 4 is a schematic depiction of an example graphical user interface of a tag association tool.

FIG. 5 is a schematic depiction of an example graphical user interface of a schema editor tool.

FIG. 6 is a schematic depiction of an example graphical user interface of a stem and conflate editor tool.

FIG. 7 is a schematic diagram depicting an example computing environment.

FIG. 8 is a schematic diagram depicting an example computing system.

### DETAILED DESCRIPTION

Media content, such as a given musical work, may have numerous subjective facets to which humans are intrinsically sensitive. It is critical to many users, including media-related organizations that own, control, or make use of a media content database, that these subjective facets be recognized and associated with media content items and their related documents in a concise and descriptive manner for quick and accurate retrieval.

In the context of musical works, for example, a growing number of music publishers and record labels generate revenue through licensing songs for usage in films, television programs, advertisements, video games, internet videos, and other audio/visual applications. Thus, it may be important to these organizations that their musical works be thoroughly described and cataloged so that the appropriate songs can be rapidly identified and delivered to clients. Consumer oriented music services such as Internet-based radio, online storefronts, and content streaming services maintain a competitive advantage by providing accurate and effective search and suggestion functionality to their clients, which is ultimately driven by the quality of their content descriptions.

Often, these organizations resort to tedious, manual data entry by qualified staff to associate specific information tags with individual musical works, which is both time consuming and costly. Automatic solutions that are employed to assist in the tagging of content typically involve computerized analysis of audio file waveforms to extract descriptive data, which has a relatively high degree of error and is often incapable of discerning many critical descriptive elements, particularly subjective facets of the content (e.g., cultural, religious, visceral, etc.). Computerized audio analysis has been used to extract data that is then combined with socialized metadata to provide enhanced descriptions. However these methodologies continue to suffer from the inaccuracies of the analysis algorithm as the “lowest common denominator.”

The present disclosure addresses these and other issues relating to the enhancement and/or categorization of media content by retrieving descriptive information that has already been attributed to a given media content item by people throughout the world wide web (i.e., network sourced information). Through a series of specific algorithms and queries, a manageable set of highly relevant terms or “tags” for that media content item are returned, given a specific and pre-defined nomenclature. These descriptive terms or tags may be used to enrich and/or categorize the media content item in a variety of ways.

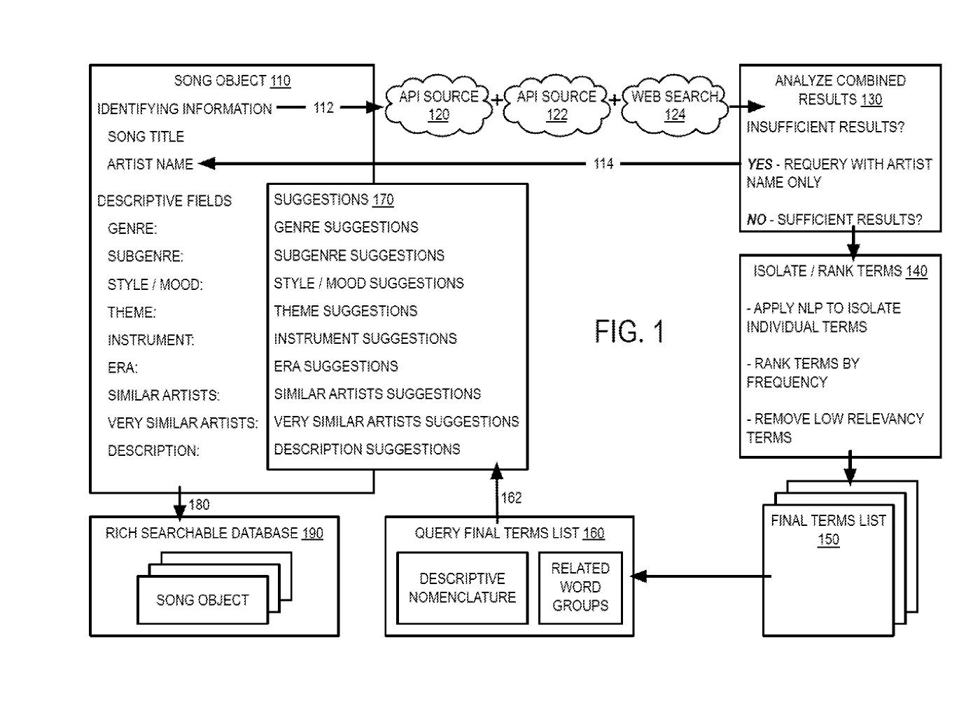

FIG. 1 is a flow diagram depicting an example process by which a media content item is enhanced and/or categorized through association with terms sourced from a variety of network resources. The example process of FIG. 1 may be performed, at least in part, by a Service implemented by a computing system.

In FIG. 1, a song object 110 takes the form of an example musical work that is to be enhanced and/or categorized. While aspects of the present disclosure may be at times described in the context of musical works, it will be understood that a musical work is merely a non-limiting example of the various forms of electronic media content to which the present disclosure may be directed, including television programs, movies, games, and electronic books, for example.

Song object 110 includes and/or is defined by identifying information, such as a song title and/or an artist name. Other forms of identifying information may be used with other forms of media content. In some examples, song object 110 may be additionally or alternatively identified by a unique identifier (e.g., a domain unique identifier or a globally unique identifier) that enables the song object to be distinguished from other song objects within a given domain or a global domain. Hence, it will be understood that a variety of different identifiers may be used to identify a particular media content item.

Song object 110 further includes or is defined by one or more descriptive fields. Non-limiting examples of descriptive fields include: (1) Genre, (2) Subgenre, (3) Style/Mood, (4) Theme, (5) Instruments, (6) Era, (7) Similar Artists, (8) Very Similar Artists, and (9) Description, among suitable descriptive fields. A media content item such as song object 110 or other forms of media may include or be defined by more or less descriptive fields and/or by different descriptive fields. Accordingly, it will be understood that aspects of the present disclosure may be applied to media content items having one or more descriptive fields of any suitable type and/or combination. As previously discussed, at least some of these descriptive fields may take the form of subjective facets of a media content item, such as mood, theme, etc.

At 112, a search query identifying a target media content item is received, and a search is performed across one or more network resources based on the search query to obtain search result information for the target media content item. In the context of a musical work, for example, the title of the song along with its artist's name is queried across one or more APIs (120, 122) and/or one or more web data resources (124) (e.g., a website and/or its various subdomains). Other web resources may include websites that contain rich social data about songs such as music blogs, online media storefronts, and/or media streaming services.

Typically, the APIs should be carefully selected by an administrator of the Service based on the quality (e.g., accuracy and/or relevancy) of the data pool accessible via the APIs. The Service may enable the administrator to add or remove APIs or websites from a set of one, two, or more web resources that are to be searched responsive to the search query. In some examples, the Service may be configured to search tens, hundreds, thousands, millions, or more network resources responsive to a search query.

At 130, the search result information may be combined and/or analyzed to determine whether the search result information is sufficient. The sufficiency of the search result information may be judged in relation to a predefined criteria, which may be user-defined in some examples. In one example, an initial analysis of the sufficiency of the search result information may be performed based on the raw quantity or volume of data returned for the media content item in response to the search query. However, other suitable techniques may be used to analyze the sufficiency of search results.

If the data is determined to be insufficient, a subsequent retrograde and/or broader search query may be performed, as indicated at 114. As one example, a subsequent search query may contain the artist name (e.g., alone or with other suitable search terms) without the song title in an attempt to retrieve a greater quantity or volume of data relating to the search query. In the context of forms media content other than musical works, retrograde and/or broadened search queries may be obtained by eliminating a title of the media content item from the search query, or by augmenting the search query in another suitable manner.

Search result information from one or more search queries is then isolated and/or ranked at 140. Many API sources may return data as a set of individual terms, however queries against other web sources may return phrases or fragments that need to be processed so that the descriptive words (e.g., which may be nouns or adjectives) may be isolated from each other or other forms of information. Various algorithms and/or applications may be implemented at this stage to remove articles, pronouns, conjunctions, punctuation marks, and other irrelevant fragments to produce a set of descriptive terms that were contained within the search result information.

Terms returned by a search query should also be mediated to avoid the ingestion of repetitive, unformatted, misspelled or inaccurate data. Network resources that may be accessed, such as media APIs, social media websites, and media blogs may not have a strict level of content description necessary for some catalogs that will be searched by professionals. Thus, before translating a set of results into the catalog nomenclature, the set of results may first be analyzed and ranked so that low relevancy terms are removed. Such analysis may be accomplished using basic natural language processing (NLP) algorithms to a) remove articles, conjunctions, pronouns and unwanted fragments b) count the frequency of certain terms and assign the highest rankings to the terms with the highest frequency c) systematically remove results that fall below a predetermined threshold of frequency. However, some music APIs deliver terms with associated relevancy ranking already determined.

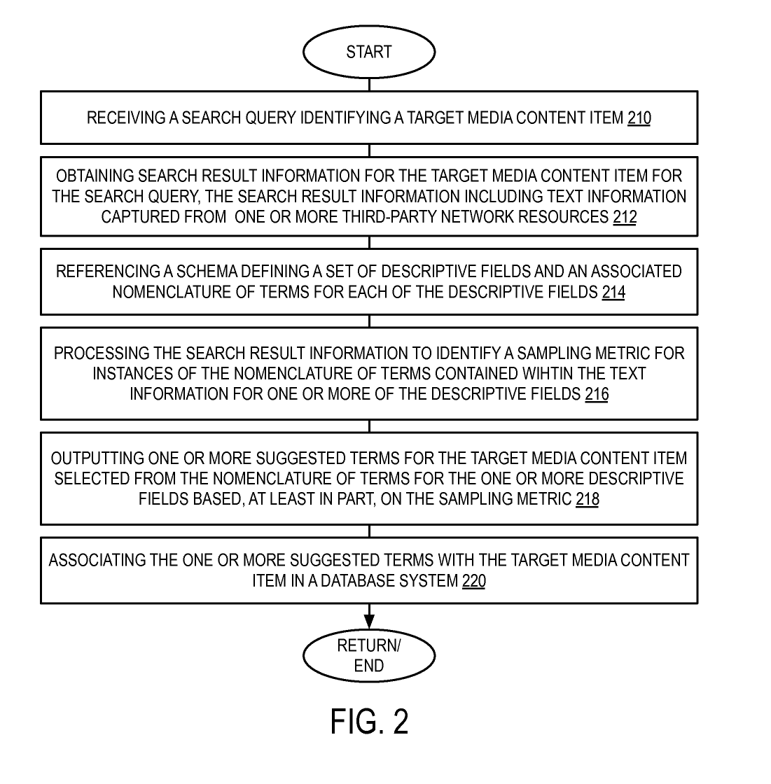

NLP is merely one example of a processing technique that may be applied to isolate and/or rank terms contained in the search query. NLP may, for example, include a matching technique, commonly known as “stemming” to translate the terms returned by the search query into the closest matching terms allowed by a catalogs schema or nomenclature. NLP may also include a technique referred to as “conflation” in which two or more terms are treated as synonyms of each other. NLP techniques will be described in greater detail with reference to FIG. 2.

Also, at 140, isolated terms may be ranked or ordered with respect to their relative frequency and/or quantity in relation to other the other terms. Terms having a relatively low relevancy (e.g., as judged by a relatively low frequency and/or quantity in relation to the other terms) may be removed or otherwise filtered from the more relevant terms. For example, the terms having a relevancy in the lower 25%, 50%, 75%, etc. or less than 10, 100, or 1,000, etc. instances in the search query information may be eliminated from the higher relevancy terms. A final terms list containing a set of higher relevancy terms is obtained at 150. In some examples, the final terms list may not be filtered.

The act of directly populating the metadata of media content with the terms returned by a query without some form of mediation would typically produce a violation of the catalog schema and compromise search engine indexing systems and the organization and conciseness of the search interface dropdowns and suggestions that may be provided to users. Therefore, a variety of techniques may be utilized for processing search result information to obtain suitable suggested terms for association with media content items.

In order to optimize search capability and improve search indexing of an online media catalog, it is beneficial to create a schema of descriptive fields or descriptive parameters (e.g., Genre, Subgenre, Theme, Style/Mood, Era, Instruments, Similar Artists, Very Similar Artists, General Description) with a discrete set of allowed terms (i.e., related word groups) in each parameter that form the catalog's nomenclature. As one example, such a schema allows the organization to offer a search interface with drop down menus and to suggest useful search terms to users.

At 160, the final terms list 150 is queried through application of a descriptive nomenclature and related word groups to produce one or more suggested terms 170. In at least some use-scenarios, a database system (e.g., a relational database or other suitable database) is constructed by qualified musicologists (or other professional depending on media type) in which each term in the catalog nomenclature is linked to a large set of similar words or phrases that are to be translated into a given catalog term.

The resulting nomenclature compliant terms 162 can then be output as suggestions 170 for a user to approve or the suggested terms may be programmatically populated into the song metadata or associated tag information. Since the terms are part of the catalog nomenclature, the terms can be divided into the different parameters according to the catalog schema. For example, Genre terms will be suggested for the Genre section of the metadata, and Theme terms will be suggested for the Theme section of the metadata, etc. Suggested terms that have been approved and/or programmatically populated at 180 for song object 110 may be stored in a rich searchable database 190, thereby providing users with an enhanced and/or categorized version of song object 110.

FIG. 2 is a flow diagram depicting an example method of categorizing a media content item. As a non-limiting example, the media content item may take the form of a musical work, such as previously described song object 110 of FIG. 1. However, the method of FIG. 2 has been generalized in relation to the process flow of FIG. 1 to potentially apply to other forms of media content items beyond musical works. The example method of FIG. 2 may be performed, at least in part, by a Service implemented by a computing system as similarly discussed with regards to the process of FIG. 1.

At 210, the method includes receiving or otherwise obtaining a search query identifying a target media content item. In at least some implementations, the method at 210 may include obtaining one or more keywords identifying the target media content item. As a non-limiting example, the one or more keywords may indicate an artist/author name, a title, and/or a unique identifier of the target media content item. For example, with regards to a musical work, the one or more keywords may indicate an artist name (e.g., musician name and/or a band name) and/or a song title. Other suitable identifiers may form the search query. The search query may be received from a client device over a communications network in scenarios where the Service is implemented at a server system.

In at least some implementations, the method at 210 may further include receiving or otherwise obtaining a user selection defining the one or more descriptive fields (e.g., a subset of descriptive fields) from the set of descriptive fields for which suggested terms are to be output by the Service responsive to the search query. For example, a user may initiate a search query and/or request suggested terms for only the Theme field or other suitable subset of the various descriptive fields. In another example, the one or more descriptive fields may include all descriptive fields of the set.

At 212, the method includes obtaining search result information for the target media content item based on the search query. In at least some implementations, the search result information includes text information captured from one or more network resources. One or more of the network resources may take the form of third-party network resources having diverse network domains (e.g., diverse top-level domains).

In at least some implementations, the search result information may be captured from a plurality of network resources having diverse domains via one or more APIs over a wide area network and/or via scraping one or more diverse publicly accessible web pages having diverse domains over the wide area network. An API of a network entity typically enables the retrieval of information from the network entity by receiving an API request message formatted according to a particular protocol supported by the API, and by responding to that API request by transmitting an API response message formatted according to the protocol supported by the API. The scraping of web pages or other publicly accessible network resources may take the form of downloading web content (e.g., HTML), and parsing that content for text information.

At 214, the method includes referencing a schema defining a set of descriptive fields and an associated nomenclature of terms for each of the descriptive fields. For example, a particular descriptive field, such as e.g., the Genre descriptive field, may include zero, one, or more acceptable terms defined by the nomenclature, such as e.g., Rock, Blues, Jazz, Folk, etc. The schema may be stored at a database system that is accessible to a computing system that implements the Service. As previously discussed, the descriptive fields and/or nomenclature may be, at least in part, user-defined.

The schema may further define stemming and conflation attributes used with application of NLP techniques. In one example, the schema defines one or more stemming terms that are each mapped to a set of two or more terms of the nomenclature. For example, if the word or phrase “Latin Music” is returned in the search result information, then the schema-translated terms may include, for the descriptive field Genre: the term “World”, for the descriptive field Subgenre: the term “Latin”, for the descriptive field Instruments: the term “Percussion”, for the descriptive field General Description: the terms “Spanish”, “Caribbean”, “South America”, etc. The word pools and relationships in this database should be carefully calibrated to ensure that the terms returned by the query are properly translated into relevant catalog nomenclature terms. The isolated and quality-ranked results can then be queried against this set of similar words and translated into a set of terms that conform to the catalog schema and nomenclature.

The schema may further define one or more sets of conflation terms in which each set of conflation terms includes two or more conflation terms that are mapped to a corresponding individual term of the nomenclature. For example, if the terms “Spanish” and “South America” are returned by the search query, the descriptive field Subgenre may include the term “Latin” as derived from the two or more terms of the search result information.

At 216, the method includes processing the search result information to identify a sampling metric for instances of the nomenclature of terms contained within the text information for one or more of the descriptive fields. In one example, the sampling metric may include a frequency of instances and/or a quantity of instances of each term of the nomenclature of terms for each of the one or more descriptive fields. However, other suitable sampling metrics or a combination of two or more sampling metrics may be used. The processing performed at 216 may utilize the schema referenced at 214.

As previously discussed, NLP techniques may be used to process the search result information at 216. For example, processing the search result information through the use of stemming may include expanding instances of a stemming term contained within the search result information to two or more corresponding terms of the nomenclature by referencing the schema to influence the sampling metric.

Within the field of NLP and information retrieval, stemming may refer to the process of reducing inflected and/or derived words to their stem or root form. It will be understood that the stem or root form need not be identical to the morphological root of the word. Rather, related words may, at times, map to the same stem or root, even if this stem is not in itself a valid root. Non-limiting examples of stemming algorithms include lookup algorithms, suffix stripping algorithms, Lemmatisation algorithms, Stochastic algorithms, n-gram analysis algorithms, suffix tree algorithms, affix stemming and/or stripping algorithms, matching algorithms, and combinations of these and/or other stemming algorithms in the form of hybrid stemming algorithms. Also, within the field of NLP and information retrieval, the treatment of words with the same stem as synonyms refers to a process called conflation. For example, the terms “1960's” and “60's” may be considered synonyms of each other.

The processing of search result information to identify instances of terms of the nomenclature within the search result information may utilize any suitable technique. FIG. 1 describes a non-limiting example of the processing that may be performed at operations 130, 140, and 160. Typically, the processing performed at 216 includes one or more of: (1) isolating raw terms contained in the search result information, (2) applying NLP, including stemming and/or conflation to aggregate processed roots or variants of those raw terms, (3) ranking or ordering the NLP processed terms to obtain an initial terms list, (4) filtering the NLP processed terms to obtain a final terms list of higher relevancy terms exhibiting at least a threshold representation within the search results relative to other NLP processed terms, and (5) mapping the terms of the final terms list to terms of the nomenclature based on stemming and/or conflation attributes defined by the schema between related word groups and each term of the nomenclature.

In at least some implementations, processing the search result information at 216 to identify a sampling metric for instances of the nomenclature of terms further includes filtering the instances of the nomenclature of terms to remove terms having less than a threshold quantity or frequency from the suggested terms, and ordering and/or ranking the remaining terms of the nomenclature of terms based on their respective quantity and/or frequency within the search result information. The threshold for filtering suggested terms based on the sampling metric may be user-defined in some examples, in terms of relative values and/or the sampling metric to be compared to such values, including e.g., relative rank, quantity, frequency, or other suitable sampling metric or combination of two or more sampling metrics.

At 218, the method includes outputting one or more suggested terms for the target media content item selected from the nomenclature of terms for the one or more descriptive fields based, at least in part, on the sampling metric. In one example, the one or more suggested terms may be output by displaying the suggested terms to a user via a graphical user interface and/or by transmitting the suggested terms to a client device over a communications network for display at the client device. In another example, the one or more suggested terms may be output to a term association module of the service to be programmatically associated with the media content item. In yet another example, the one or more suggested terms may be output to a data manager module of the Service or third-party network entity for storage in a database system. It will be understood that a set of zero, one, or more suggested terms may be output for each descriptive field with some descriptive fields potentially including tens, hundreds, or more suggested terms depending on the nomenclature and contents of the search results.

As previously discussed, the sampling metric may include a quantity or a frequency of instances of each term of the nomenclature of terms for each of the one or more descriptive fields. In at some implementations, terms of the nomenclature having a higher or greater sampling metric relative to other terms of the nomenclature may be output as suggested terms. By contrast, terms of the nomenclature having a lower sampling metric relative to other terms of the nomenclature may be excluded from the suggested terms. However, in other examples, all terms of the nomenclature that are present in the search result information (before and/or after application of NLP or other forms of processing) may be output as suggested terms. Terms that are duplicative of terms already associated with the media content item may be omitted from a set of suggested terms in some examples.

At 220, the method includes associating one or more suggested terms with the target media content item in a database system. In one example, only some or all of the suggested terms may be associated with media content items through human intervention, such as e.g., responsive to a user selection of a subset of suggested terms from a superset of suggested terms. In another example, only some or all of the suggested terms may be automatically or programmatically associated with media content items, for example, responsive to those suggested terms exceeding or exhibiting at least a threshold frequency, quantity, or other filtering of a sampling metric value, or by satisfying other suitable conditions. These threshold values, the sampling metrics applied to the threshold values, and other suitable conditions may be user-defined in at least some implementations, and may vary depending on the type of media content item and/or the domain of information captured by the search results.

Suggested terms that have been associated with a media content item may be referred to as associated terms or associated tags. A suggested term may be associated with a media content item in a variety of ways, such as by storing information representing the suggested term within a file wrapper of the media content item (e.g., as metadata) or by storing information representing the suggested term within a relation database that is linked to an identifier of the media content item. In one example, one or more suggested terms may be associated with a target media content item by storing the one or more suggested terms in a metadata tag field of the target media content item. In another example, one or more suggested terms may be associated with a target media content item by storing the one or more suggested terms in a database field of a database system that is linked to the target media content item. In either example, the suggested terms associated with a media content item (i.e., associated terms) may be referenced as part of a search query or other information request to enable retrieval, categorization, filtering, or sorting of that media content item in relation to other media content items.

As previously discussed with reference to FIG. 1, responsive to a value of the sampling metric falling below a threshold, broadening of the search query may be optionally performed by removing or augmenting one or more keywords describing the target media content item. For example, an initial search query conducted at 210 based on the artist name and title may be broadened by initiating a subsequent search query at 210 based on the artist name while omitting the title of the media content item from the subsequent search query. In such case, updated search result information may be obtained for the target media content item responsive to the broadened search query at 212. The updated search result information may include additional and/or different text information captured from one or more network resources. However, in some instances, artist name queries alone may trigger restrictions on the availability or ability to generate suggested terms for some of the descriptive fields. For example, some descriptive fields, such as Theme may be ignored, omitted, or unreported for artist name queries that do not include the song title, since Theme is often song specific and may not be identified from the artist name alone.

The updated search result information may be processed at 216 to identify an updated sampling metric for instances of the nomenclature of terms contained within the additional or different text information for one or more of the descriptive fields. One or more suggested terms may be output at 218 for the target media content item that are selected from the nomenclature of terms for the one or more descriptive fields based, at least in part, on the updated sampling metric. One or more of the suggested terms obtained from the updated search result information may be associated with the target media content item at 220.

It will be understood that the various sub-processes or operations of previously described FIGS. 1 and 2 may be, at times, performed in a different order and/or some of the sub-processes or operations may be, at times, omitted or repeated.

The Service described herein may support a number of user tools that facilitate various aspects of the disclosed processes and methods. In some examples, each of these user tools may be implemented by a respective module of the Service. Non-limiting examples of these user tools include: (1) a search tool that enables a user to define a search query, initiate a search based on the search query, and obtain search results for the search query; (2) a tag association tool that enables a user to associate suggested tags with a media content item in a database system; (3) a schema editor tool that enables a user to create, modify, and/or delete schema attributes associate with descriptive fields; (4) a stem and conflate editor tool that enables a user to create, modify, and/or delete attributes of the stemming and/or conflation natural language processes; or other suitable tools. One or more of these tools may be accessed by a user via a graphical user interface (GUI).

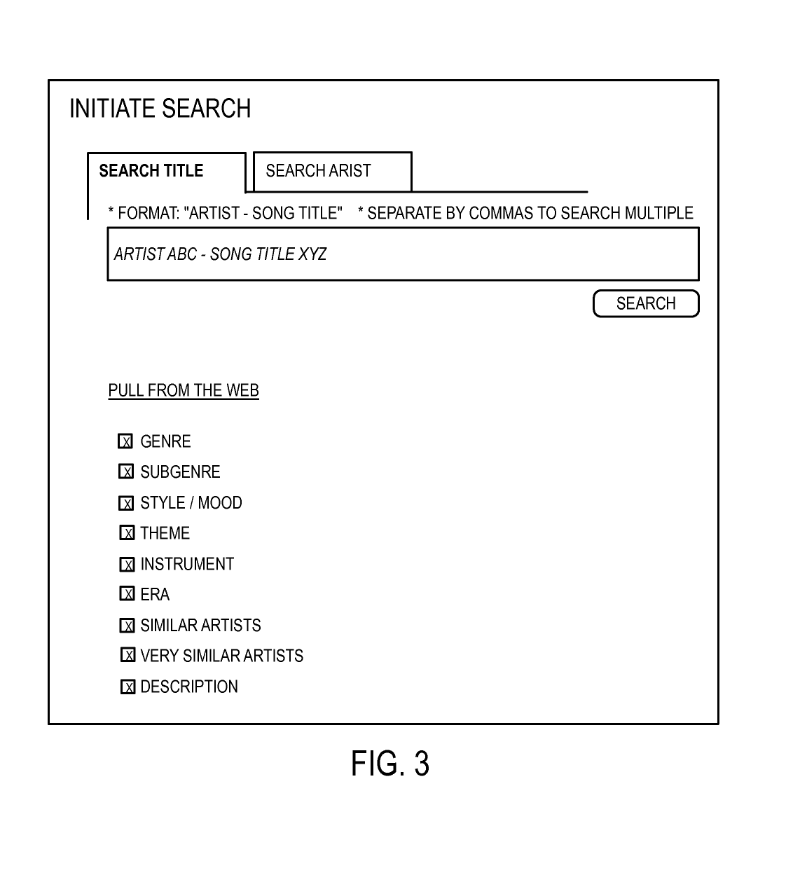

FIG. 3 is a schematic depiction of an example graphical user interface of a search tool that may be supported by the Service disclosed herein. The GUI of FIG. 3 includes one or more selectors (e.g., tabs labeled “SEARCH TITLE” and “SEARCH ARTIST”) that enables a user to utilize either a song title search in combination with the artist name, or an artist search that does not include the song title. In other implementations, a selector may be provided to enable a user to utilize a song title search without the artist name.

Within the GUI of FIG. 3, the “SEARCH TITLE” selector has been selected, and the search query “ARTIST ABC-SONG TITLE XYZ” has been entered into a search query field of the GUI. The search may be initiated by the Service upon a user's selection of a “SEARCH” selector, for example. The GUI of FIG. 3 also includes respective selectors (e.g., under the “PULL FROM THE WEB” sub-header) for including or excluding individual descriptive fields with respect to the search query. For example, a user may limit a search to only the Genre descriptive field by checking only the “GENRE” selector while excluding the other descriptive fields. In such case, the Service would return suggested terms applicable to the Genre descriptive field. However, within FIG. 3, all descriptive fields have been selected, in which case, a set of zero, one, or more suggested terms would be returned for each descriptive field depending on the contents of the search result information obtained for that search query.

The GUI of FIG. 3 also enables a user to search for multiple media content items within a single search query. It will be appreciated that in some implementations, a search tool may enable a user to programmatically generate a search query across an entire catalog or library of media content items (or user-defined portions of the catalog or library) by initiating an individual search query command. For example, a record label or content provider could designate portions of their catalogs or libraries that are to be enhanced and/or categorized by the disclosed Service without requiring that individual search queries be manually initiated by a user for each separate media content item.

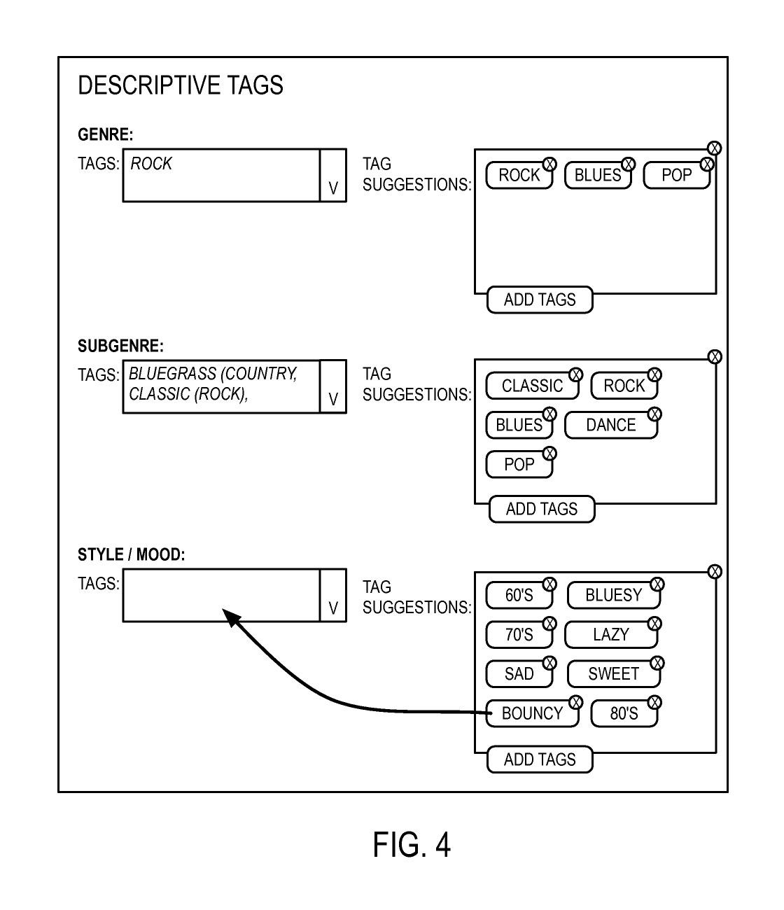

FIG. 4 is a schematic depiction of an example graphical user interface of a tag association tool that may be supported by the Service disclosed herein. Within the GUI of FIG. 4, the genre, subgenre, and style/mood descriptive fields are presented. It will be understood that any suitable number and/or type of descriptive fields may be presented. Terms that have already been added to each descriptive field (either by user selection/approval or by programmatic techniques not involving direct user interaction) are displayed in the “TAGS” field of the corresponding descriptive fields. By contrast, terms that have been suggested, but not yet added to the descriptive fields are displayed in the “TAG SUGGESTIONS” field. For example, the term “BOUNCY” is located within the TAG SUGGESTIONS field has been suggested for the Style/Mood descriptive field, but has not yet been associated with the Style/Mood descriptive field. A user may associate the BOUNCY term with the Style/Mood descriptive field by dragging and dropping that term from the TAG SUGGESTIONS field to the Style/Mood field, for example. It will be appreciated that other suitable actions may be used to associate or dissociate terms with or from a descriptive field. Also within FIG. 4, a user may delete suggested terms from the TAG SUGGESTIONS field or a descriptive field association by selecting a selector denoted with an “X” associated with each suggested term. A user may add terms to the TAG SUGGESTIONS field by selecting an “ADD TAGS” selector, for example, and by typing or dragging and dropping a new term into the TAG SUGGESTIONS field.

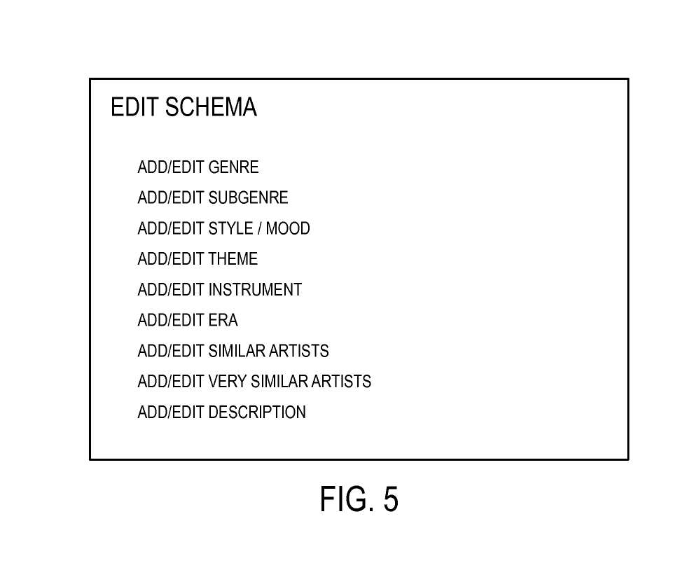

FIG. 5 is a schematic depiction of an example graphical user interface of a schema editor tool that may be supported by the Service disclosed herein. Within the GUI of FIG. 5, a selector (e.g., “ADD/EDIT”) associated with each descriptive field enables a user to add, modify, and/or delete schema attributes for that descriptive field. For example, a user may select the ADD/EDIT selector associated with the Style/Mood descriptive field to add or remove allowable terms to or from the nomenclature for a particular Style/Mood descriptive field, or to delete or deactivate the Style/Mood descriptive field from the schema. A GUI for the schema editor tool may further include a selector that enables a user to add new descriptive fields to the schema.

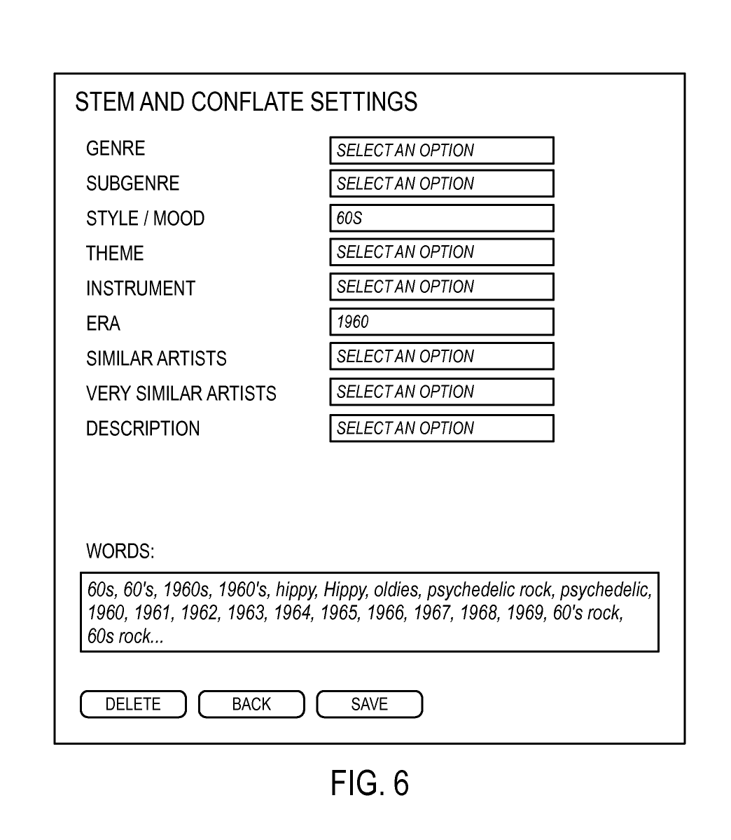

FIG. 6 is a schematic depiction of an example graphical user interface of a stem and conflate editor tool that may be supported by the Service disclosed herein. The GUI of FIG. 6 includes a “WORDS” field in which a set of terms contained in the search result information may be linked to a term of the nomenclature for one or more of the descriptive fields. In FIG. 6, the GUI further includes a respective field or menu selector in which a term of the nomenclature to be linked to the terms contained in the WORDS field is presented. For example, In FIG. 6, the respective field or menu selector for the Style/Mood descriptive field is displaying the term “60S”, which has been linked to the various terms contained in the WORDS field, such as “60s”, “60's”, “1960s”, etc. Additionally, in FIG. 6, the respective field or menu selector for the Era field is displaying the term “1960”, which has also been linked to the various terms contained in the WORDS field. By contrast, the remaining descriptive fields have not been linked to the currently presented WORDS field as indicated by the “SELECT AN OPTION” designation. The GUI of FIG. 6 further includes a delete selector for deleting a link between a term of a descriptive field and the terms contained in the WORDS field, a save selector for saving or creating a link between a term of a descriptive field and the terms contained in the WORDS field, and a back selector for returning to a menu of one or more other tools and related GUIs.

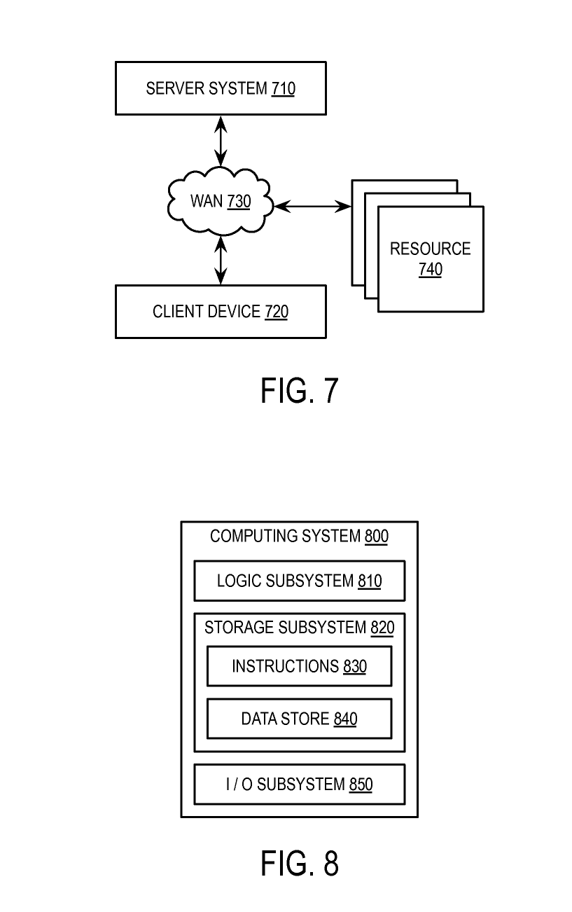

FIG. 7 is a schematic diagram depicting an example computing environment in which one or more client devices (e.g., example client device 720) communicate with a server system 710 over a communications network, such as wide area network (WAN) 730. As one example, WAN 130 takes the form of the Internet or a portion thereof. It will be understood that other suitable communications networks may be used to facilitate communications between clients and server systems, including one or more local area networks (LANs) in addition to or as an alternative to WAN 730.

In at least some implementations, the Service disclosed herein may reside at and/or be performed or otherwise implemented by server system 710. Server system 710 may include one or more server devices that are co-located and/or geographically distributed. A media content catalog and/or library may also reside at server system 710, or may reside at a different networked server system or device. Client device 720 may take the form of a personal computer or interface device that is operated by a user. In one example, client device 720 may be operated by an administrator for a media content catalog or content delivery service.

Server system 710 and/or client devices (including example client device 720) may access network resources (e.g., including example network resource 740) via WAN 730. Network resources may be hosted at respective server devices or other suitable networked equipment, and may include, for example, information containing human generated content in the form of reviews, critiques, discussions, and editorials that are published online via websites, weblogs, electronic publications, multi-party discussion forums, and social networks. Network resources may be accessible via an API and/or through standard web resource requests to publicly accessible resources and/or restricted resources.

A user of client device 720 may utilize one or more GUIs presented at client device 720 to access one or more tools supported by the Service residing at server system 710. For example, the user may direct or otherwise cause the Service residing at server system 710 to enhance and/or categorize one or more target media content items of a media content catalog or library using information published by network resources, such as network resource 740. In such case, the server system 710 may perform one or more of the processes and/or methods previously described with reference to FIGS. 1 and 2. In other implementations, the Service and/or media content catalog/library or portions thereof may reside at a client device, in which case, server system 710 may be omitted or limited in use.

As previously discussed, the above described methods and processes may be tied to a computing system including one or more computing devices. In particular, the methods and processes described herein may be implemented as one or more applications, services, application programming interfaces, computer libraries, and/or other suitable computer programs or instruction sets.

FIG. 8 is a schematic diagram depicting an example computing system 800 that may perform one or more of the above described methods and processes. Computing system 800 is shown in simplified form. It is to be understood that virtually any computer architecture may be used without departing from the scope of this disclosure. Computing system 800 or portions thereof may take the form of one or more of a mainframe computer, a server computer or server system of two or more server computers, a personal computer such as a desktop computer, a laptop computer, a tablet computer, a home entertainment computer, a network computing device, a mobile computing device, a mobile communication device, a gaming device, television set-top box/cable box, a computer integrated within a television (e.g., smart TV or internet enabled TV), or a wearable computing device, etc. In the context of a server system, computing system 800 may take the form of one or more server devices that are co-located at a common location or geographically distributed across two or more different locations that communicate with each other via a communications network.

Computing system 800 includes a logic subsystem 810 and a computer readable information storage subsystem 820. Computing system 800 may further include an input/output subsystem 850. Logic subsystem 810 includes one or more physical, tangible devices (i.e., machines) configured to execute instructions, such as example instructions 830 held in storage subsystem 820. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

As a non-limiting example, logic subsystem 810 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by one or more remotely accessible networked computing devices configured in a cloud computing configuration.

Storage subsystem 820 includes one or more physical, tangible, non-transitory, devices (e.g., a computer readable storage device) configured to hold data in data store 840 and/or instructions 830 executable by the logic subsystem to implement the herein described methods and processes. When such methods and processes are implemented, the state of storage subsystem 820 may be transformed (e.g., to hold different data or other suitable forms of information). Hence, computing system 800 may, for example, perform one or more of the methods and processes described herein by accessing instructions 830 from storage subsystem 820 and executing instructions 830.

Storage subsystem 820 may additionally or alternatively include removable media and/or built-in devices. Storage subsystem 820 may include optical memory devices (e.g., CD, DVD, HD-DVD, Blu-Ray Disc, etc.), semiconductor memory devices (e.g., FLASH, RAM, EPROM, EEPROM, etc.) and/or magnetic memory devices (e.g., hard disk drive, floppy disk drive, tape drive, MRAM, etc.), among others. Storage subsystem 820 may include devices with one or more of the following characteristics: volatile, nonvolatile, dynamic, static, read/write, read-only, random access, sequential access, location addressable, file addressable, and content addressable. In at least some implementations, the logic subsystem and storage subsystem may be integrated into one or more common devices, such as an application specific integrated circuit or a system on a chip.

It is to be appreciated that storage subsystem 820 includes one or more physical, tangible, non-transitory devices. In contrast, in at least some implementations and under select operating conditions, aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be, at times, propagated by a pure signal.

The terms “module” or “program” may be used to describe an aspect of a computing device that is implemented to perform one or more particular functions. In some cases, such a module or program may be instantiated via logic subsystem 810 executing instructions 830 held by storage subsystem 820. It is to be understood that different modules or programs may be instantiated from the same application, service, code block, object, library, routine, API, function, etc. Likewise, the same module or program may be instantiated by different applications, services, code blocks, objects, routines, APIs, functions, etc. The terms “module” or “program” are meant to encompass individual or groups of executable files, data files, libraries, drivers, scripts, database records, etc. Examples of software include an operating system, an application program such as the previously described authoring application program and/or viewer application program, a plug-in, a software update, a software portion, or combinations thereof.

It is to be appreciated that a “service”, as used herein, may be an application program or other suitable instruction set executable across multiple sessions and available to one or more system components, programs, and/or other services. In at least some implementations, a service may run on a server or collection of servers responsive to a request from a client. In another implementation, a service may run on a client computing device.

Input/output subsystem 850 may include and/or otherwise interface with one or more input devices and/or output devices. Examples of input devices include a keyboard, keypad, touch-sensitive graphical display device, touch-panel, a computer mouse, a pointer device, a controller, an optical sensor, a motion and/or orientation sensor (e.g., an accelerometer, inertial sensor, gyroscope, tilt sensor, etc.), an auditory sensor, a microphone, etc. Examples of output devices include a graphical display device, a touch-sensitive graphical display device, an audio speaker, a haptic feedback device (e.g., a vibration motor), etc. When included, a graphical display device may be used to present a visual representation of data held by the storage subsystem. As the herein described methods and processes change the data held by the storage subsystem, and thus transform the state of the storage subsystem, the state of the graphical display may likewise be transformed to visually represent changes in the underlying data.

Input/output subsystem 850 may further include a communication subsystem that is configured to communicatively couple computing system 800 with one or more other computing devices or computing systems. The communication subsystem may include wired and/or wireless communication devices compatible with one or more different communication protocols. As an example, the communication subsystem may be configured for communication via a wireless telephone network, a wireless local area network, a wired local area network, a wireless personal area network, a wired personal area network, a wireless wide area network, a wired wide area network, etc. In at least some implementations, the communication subsystem may enable the computing system to send and/or receive messages to and/or from other devices via a communications network such as the Internet or portions thereof, for example.

It is to be understood that the configurations and/or approaches described herein are exemplary in nature, and that these specific embodiments or examples are not to be considered in a limiting sense, because numerous variations are possible. The specific processes, routines, or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof. It should be understood that the disclosed embodiments are illustrative and not restrictive. Variations to the disclosed embodiments that fall within the metes and bounds of the claims, now or later presented, or the equivalence of such metes and bounds are embraced by the claims.

1. A method of enhancing and/or categorizing a media content item, the method comprising:
receiving a search query identifying a target media content item;
obtaining search result information for the target media content item for the search query, the search result information including text information captured from one or more third-party network resources;
referencing a schema defining a set of descriptive fields and an associated nomenclature of terms for each of the descriptive fields;
processing the search result information to identify a sampling metric for instances of the nomenclature of terms contained within the text information for one or more of the descriptive fields; and
outputting one or more suggested terms for the target media content item selected from the nomenclature of terms for the one or more descriptive fields based, at least in part, on the sampling metric.

2. The method of claim 1, wherein the sampling metric includes a quantity or frequency of instances of each term of the nomenclature of terms for each of the one or more descriptive fields.

3. The method of claim 2, further comprising:
obtaining a user selection defining the one or more descriptive fields from the set of descriptive fields.

4. The method of claim 2, wherein the one or more descriptive fields includes all descriptive fields of the set.

5. The method of claim 1, wherein the schema further defines one or more stemming terms that are each mapped to two or more terms of the nomenclature; and
wherein processing the search result information includes expanding instances of a stemming term contained within the search result information to two or more corresponding terms of the nomenclature by referencing the schema to influence the sampling metric.

6. The method of claim 1, wherein the schema further defines one or more sets of conflation terms in which each set of conflation terms includes two or more conflation terms that are mapped to a corresponding individual term of the nomenclature; and
wherein processing the search result information includes combining instances of the two or more conflation terms of a set of conflation terms within the search result information to the corresponding individual term of the nomenclature by referencing the schema to influence the sampling metric.

7. The method of claim 1, wherein receiving the search query identifying the target media content item includes obtaining one or more keywords identifying the target media content item, the one or more keywords indicating an author/artist name and/or a title and/or a unique identifier of the target media content item.

8. The method of claim 7, wherein the media content item takes the form of a musical work, and wherein the one or more keywords indicates an artist name and/or a song title.

9. The method of claim 1, wherein processing the search result information to identify a sampling metric for instances of the nomenclature of terms further includes:
filtering the instances of the nomenclature of terms to remove terms having less than a threshold quantity or frequency from the suggested terms; and
ordering and/or ranking the remaining terms of the nomenclature of terms based on their relative quantity and/or frequency within the search result information.

10. The method of claim 1, further comprising:
performing the search based on the search query to obtain the search result information for the target media content item from the one or more third-party network resources over a wide area network;
wherein obtaining the search result information captured from the one or more third-party network resources includes obtaining the search result information from a plurality of third-party network resources having diverse domains via one or more diverse APIs over the wide area network and/or via scraping multiple diverse publicly accessible web pages over the wide area network.

11. The method of claim 1, further comprising, associating the one or more suggested terms with the target media content item in a database system.

12. The method of claim 11, wherein the one or more suggested terms takes the form of a super set of suggested terms; and
wherein associating the one or more suggested terms with the target media content item is performed responsive to a user selection of a subset of the one or more suggested terms from the superset of the one or more suggested terms, and
wherein associating the one or more suggested terms includes associating only the subset of the one or more suggested terms with the target media content item.

13. The method of claim 12, wherein associating the subset of suggested terms with the target media content item includes:
storing the subset of suggested terms in a metadata tag field of the target media content item; or
storing the subset of suggested terms in a database field of the database system that is linked to the target media content item.

14. The method of claim 11, wherein associating the one or more suggested terms with the target media content item is performed for each suggested term responsive to that suggested term having a sampling metric value that exceeds a threshold value.

15. The method of claim 1, further comprising:
responsive to a value of the sampling metric falling below a threshold, broadening the search query by removing or augmenting one or more keywords describing the target media content item;
obtaining updated search result information for the target media content item responsive to the broadened search query, the updated search result information including additional and/or different text information captured from one or more third-party network resources;
processing the updated search result information to identify an updated sampling metric for instances of the nomenclature of terms contained within the additional or different text information for one or more of the descriptive fields; and
outputting the one or more suggested terms for the target media content item selected from the nomenclature of terms for the one or more descriptive fields based, at least in part, on the updated sampling metric.

16. An article, comprising:
a computer readable storage device having instructions stored thereon executable by a computer or a computing system to:
receive a search query identifying a target media content item;
obtain search result information for the target media content item for the search query, the search result information including text information captured from one or more third-party network resources;
reference a schema at a database system, the schema defining a set of descriptive fields and an associated nomenclature of terms for each of the descriptive fields;
process the search result information to identify a sampling metric for instances of the nomenclature of terms contained within the text information for one or more of the descriptive fields;
output one or more suggested terms for the target media content item selected from the nomenclature of terms for the one or more descriptive fields based, at least in part, on the sampling metric; and
associate at least some of the one or more suggested terms with the target media content item in the database system.

17. The article of claim 16, wherein the media content item takes the form of a musical work; and
wherein the computer readable storage device further has instructions stored thereon executable by the computing system to:
obtain the search query identifying the target media content item as one or more keywords indicating an artist name and/or a song title of the target media content item.

18. The article of claim 17, wherein the computer readable storage device further has instructions stored thereon executable by the computing system to:
obtain the search result information from a plurality of third-party network resources having diverse domains via one or more APIs over a wide area network and/or via scraping one or more diverse publicly accessible web pages having diverse domains over the wide area network.

19. The article of claim 18, wherein the computer readable storage device further has instructions stored thereon executable by the computing system to:
process the search result information to identify the sampling metric for instances of the nomenclature of terms by:
filtering the instances of the nomenclature of terms to remove terms having less than a threshold quantity or frequency from the suggested terms, and
ordering and/or ranking the remaining terms of the nomenclature of terms based on their respective quantity and/or frequency within the search result information; and
associate a subset of the one or more suggested terms with the target media content item in the database system responsive to and defined by a user selection of the subset from the remaining terms.

20. A method of enhancing and/or categorizing a media content item by a computing system, the method comprising:
receiving a search query identifying a target media content item that takes the form of a musical work, the search query including one or more keywords that indicate an artist name and/or a song title;
performing a search based on the search query to obtain search result information for the target media content item from one or more third-party network resources over a wide area network, the search result information including text information captured from the one or more third-party network resources;
referencing a schema defining a set of descriptive fields and an associated nomenclature of terms for each of the descriptive fields;
processing the search result information using natural language processing to identify a sampling metric for instances of the nomenclature of terms contained within the text information for one or more of the descriptive fields, the sampling metric including a quantity or frequency of instances of each term of the nomenclature of terms for each of the one or more descriptive fields;
outputting one or more suggested terms for the target media content item selected from the nomenclature of terms for the one or more descriptive fields based, at least in part, on the sampling metric;
receiving a user selection of at least some of the one or more suggested terms; and
associating suggested terms selected by the user with the target media content item in a database system.
